(19) United States
(12) Patent Application Publication
(10) Pub. No.: US 2026/0326024 A1
(43) Pub. Date: Oct. 22, 2026

(54) MULTI-STAGE HEAT AND MASS TRANSFER USING CO-CURRENT AND COUNTER-CURRENT FLOW

(71) Applicant: INDUSTRIAL CLIMATE SOLUTIONS INC., Calgary (CA)

(72) Inventors: Hossein Khorshidian, Calgary (CA); William Hargrove, Easton, MD (US); Jahan Ahmadi, Calgary (CA)

(21) Appl. No.: 19/184,461

(22) Filed: Apr. 21, 2025

(51) Int. Cl. B01D 53/18; B01D 53/14

(52) U.S. Cl. CPC B01D 53/185; B01D 53/1412; B01D 53/1475

(57) ABSTRACT

A heat and mass transfer system includes an absorption system including a series of absorption modules, each absorption module of the series of absorption modules configured to receive a process fluid and a liquid. The process fluid is configured to flow through the series of absorption modules in a first direction, and the process fluid and the liquid are configured to flow co-currently within each absorption module. The heat and mass transfer system also includes a circulation system configured to collect a portion of the liquid from an output of a latter absorption module and circulate the portion of the liquid to an input of a different absorption module, the different absorption module located before the latter absorption module in the series.

### BACKGROUND

In various industries, including the resource recovery and fluid sequestration industries, capture of various byproducts and/or generated gases may be necessary or desirable. For example, capture of environmentally threatening gasses such as CO₂ from the exhaust streams of hydrocarbon-fueled processes has become prevalent. Furthermore, such capture technologies may be used for other chemicals and/or processes, including, without limitation: natural gas production, sweetening, and the like.

### SUMMARY

An embodiment of a heat and mass transfer system includes an absorption system including a series of absorption modules, each absorption module of the series of absorption modules configured to receive a process fluid and a liquid. The process fluid is configured to flow through the series of absorption modules in a first direction, and the process fluid and the liquid are configured to flow co-currently within each absorption module. The heat and mass transfer system also includes a circulation system configured to collect a portion of the liquid from an output of a latter absorption module and circulate the portion of the liquid to an input of a different absorption module, the different absorption module located before the latter absorption module in the series.

An embodiment of a method includes inputting a process fluid into a series of absorption modules, each absorption module of the series of absorption modules defining an absorption stage and configured to receive the process fluid and a liquid. The process fluid is configured to flow through the series of absorption modules in a first direction. The method also includes inputting the liquid into an absorption stage, and flowing the liquid co-currently through the absorption stage with the process fluid, each absorption module causing a transfer of a target species from the process fluid to the liquid. The method further includes circulating a portion of the liquid from an output of a latter absorption module to an input of a different absorption module by a circulation system, the different absorption module located before the latter absorption module in the series, to cause the circulated portion to flow counter-currently relative to the process fluid.

### BRIEF DESCRIPTION OF THE DRAWINGS

The following descriptions should not be considered limiting in any way. With reference to the accompanying drawings, like elements are numbered alike:

FIG. 1 is a side view of an embodiment of a heat and mass transfer system including a set of absorption stages, and one or more fluid control systems;

FIG. 2 is a side view of an embodiment of a heat and mass transfer system including a set of absorption stages, and a circulation system;

FIG. 3 is a side view of an embodiment of a heat and mass transfer system including a set of absorption stages, and a circulation system;

FIGS. 4A and 4B depict graphs of a mole ratio of a solute in gas as a function of a mole ratio of the solute in a liquid;

FIG. 5 depicts a graph of a mole ratio of a solute in gas as a function of a mole ratio of the solute in a liquid;

FIG. 6 is a side view of an embodiment of a heat and mass transfer system including horizontally arrayed absorption stages;

FIG. 7 is a side view of an embodiment of a heat and mass transfer system including two sets of absorption stages connected in parallel;

FIG. 8 is a side view of an embodiment of a heat and mass transfer system including two sets of absorption stages connected in parallel; and

FIG. 9 is a top cross-sectional view of an embodiment of a two-dimensional absorption stage.

### DETAILED DESCRIPTION

A detailed description of one or more embodiments of the disclosed apparatus and method are presented herein by way of exemplification and not limitation with reference to the Figures.

Systems and methods are described herein for transfer of heat and mass between immiscible fluids having different densities. In an embodiment, the fluids include a gas that is desired to be captured or sequestered, or a gas having one or more components or target species that are desired to be captured by a liquid solvent. For example, the fluids include gas produced from a formation during a hydrocarbon production or combustion process, and a liquid for absorption of desired target species. The component(s) or target species to be captured may be carbon dioxide and/or any other compound or component.

An embodiment of a heat and mass transfer system (e.g., a carbon dioxide separation system) includes a series of absorption modules, defining multiple stages for heat and mass transfer. Each absorption module is configured to receive a process fluid (e.g., flue gas or contaminated air) and a liquid (e.g., solvent) and facilitate a physical and/or chemical reaction (e.g., absorption) between the process fluid and the liquid via enhancing the contact area and promoting the residence time of immiscible fluid interfaces. The physical and/or chemical reaction causes a target species in the process fluid (e.g., carbon dioxide or other solute) to be absorbed by the liquid solvent.

In an embodiment, the heat and mass transfer system includes a control system having one or more valves or other fluid control devices in communication with a controller. The control system allows for adjustment of operational parameters, such as flow rate, temperature and liquid/gas ratio. The operational parameters may be adjusted prior to and/or during an operation to improve or optimize hydrodynamics, and/or to fulfill gas and liquid loadings based on the process demands.

In an embodiment, the heat and mass transfer system includes multiple stages, where process fluid (e.g., gas) and liquid (e.g., solvent) flow concurrently within each stage, and flow counter-currently between stages. For example, a circulation system is configured to circulate liquid (which has already flowed through one or more stages) back into the system. The circulation system may also include one or more temperature control devices to reduce a temperature of circulated liquid before returning to the system. The circulation system may also include a section for each stage, as described herein.

The stages of the heat and mass transfer system may be arrayed vertically as a series (e.g., to allow gravity to facilitate movement of fluids through the system). In an embodiment, the stages are arranged in parallel (e.g., horizontally) as two separate batches of stages. The system in this embodiment may be configured so that different types of solvent systems can be loaded into different batches of stages.

Embodiments described herein present a number of advantages. For example, embodiments allow for the use of less solvent than is typically needed for carbon capture and other absorption/separation processes. Embodiments may also reduce the need for more expensive solvents, reducing system costs. In addition, embodiments provide for real time control of operational parameters, which allows operators to operate the system at its optimal performance when process conditions change (e.g., a turbine generator may produce various level of flue gas at different times).

In addition, embodiments provide for more compact systems that can be deployed rapidly and do not require intensive work (e.g., building massive infrastructure and foundations for highly elevated columns). In addition, embodiments of the system may be configured as a modular system that can be delivered as pre-assembled or modular package.

Embodiments also present advantages due to combinations of co-current and counter-current flow as described herein. Separation processes, such as absorption or distillation, usually require segregation of target species within one or more fluids beyond their simple equilibrium conditions. Heat and mass transfer structures that exclusively utilize co-current fluid flow may be limited with regards to achievable performance within one stage. The embodiments described herein provide for improved heat and mass transfer beyond this equilibrium limitation.

The embodiments may be configured for various types of heat and mass transfer, such as absorption or distillation. The embodiments may be used for desorption or gas saturation (by evaporation of a liquid fluid or vaporization of a component or species within the liquid), “gas quenching” (e.g., gas cooling by mixing with cold liquid) and other processes.

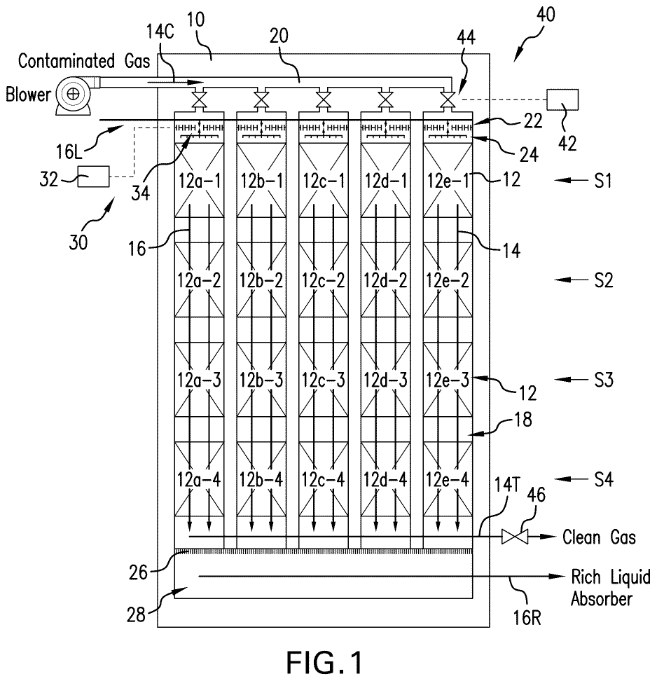

FIG. 1 depicts a heat and mass transfer system 10, e.g., for use in extracting a desired chemical, compound, or material from a fluid. The fluid may be gaseous mixture, such as flue gas from a power plant (e.g., fossil fuel or other fuel source), gas extracted from a subterranean region (e.g., hydrocarbon bearing formation), or any other suitable fluid from which carbon dioxide or other gases is desired to be removed.

In an embodiment, the heat and mass transfer system 10 functions as an absorption facility that captures a desired material (e.g., carbon dioxide) by flowing a process fluid through a plurality of absorption stages, along with a liquid solvent. In the following, the heat and mass transfer system 10 is described as an absorption system 10; however, it is understood that the system 10 may be utilized in any desired context in which heat and/or mass transfer between fluids is desired.

The absorption system 10 includes plurality of absorption stages, in which each absorption stage includes one or more reaction or absorption modules 12. Each absorption module 12 is configured to operate according to a co-current flow regime. In each absorption module 12, a process fluid such as a gas 14 (e.g., flue gas) and a liquid such as a solvent 16 (e.g., water, amine-based solvent, etc.) flow co-currently (i.e., in the same overall direction). For example, as discussed further herein, the gas 14 and the solvent 16 flow vertically downward from a location above an absorption module 12 to a location below the absorption module 12. The co-current flow regime significantly intensifies the gas/liquid contact area at their interfaces, enhancing the mass transfer.

The absorption stages may be arrayed vertically in a column. In addition, each absorption stage may include multiple absorption modules 12 operating in parallel. Flow of fluids between adjacent absorption modules 12 in a column is achieved by a connector 18, which includes one or more conduits or volumes that provide fluid communication between absorption modules 12 in a column.

For example, as shown in FIG. 1, the absorption system 10 includes a series of vertically arrayed absorption stages, denoted as stages S1, S2, S3 and S4. Stage S1 includes a horizontal array of absorption vessels 12 (denoted as vessels 12a-1, 12b-1, 12c-1, 12d-1 and 12e-1), and stage S2 includes a horizontal array of absorption vessels 12 (denoted as vessels 12a-2, 12b-2, 12c-2, 12d-2 and 12e-2). Stage S3 includes a horizontal array of absorption vessels 12 (denoted as vessels 12a-3, 12b-3, 12c-3, 12d-3 and 12e-3), and stage S4 includes a horizontal array of absorption vessels 12 (denoted as vessels 12a-4, 12b-4, 12c-4, 12d-4 and 12e-4).

The number of stages, as well as the number of absorption modules 12 in a given stage, is not limited to the specific examples described herein. The number of absorption modules 12 in each stage may be selected based on factors such as the amount of process fluid being processed, the concentration of a target species in the process fluid, fluid compositions, and others. The number of stages stacked vertically depends on factors such as the concentration of target species in the contaminated gas entering the system and clean gas leaving the system. Other operational parameters such as the type of solvent, the system pressure and temperature, the type of porous media used in every stage, and the targeted pressure drop also influence the number of steps.

In an embodiment, the absorption stage or stages is/are configured as a Regenerative Froth Contactor (RFC) system, which can increase the mass-transfer between a gas stream (e.g., carbon-rich flue gasses) and an absorbent liquid solvent. For example, each absorption module 12 includes a vessel (or portion of a body defining a column) that houses an RFC.

The primary mechanism of an RFC system allows increased mass transfer through the generation of a pulsating flow regime inside a gas-liquid contactor such that the majority of the internal volume of the contactor is occupied by a pulsating froth of micro-scale gas bubbles and liquid droplets. An RFC system may be substantially passive in the sense that the frothing is achieved by supplying a substantially constant pressure and flowrate of the gas and liquid solvent through a vessel having a series of packing elements (e.g., mesh screens or the like).

An RFC may employ specialized Corrugated Screen Packing (CSP) to produce a pulsing gas/liquid flow regime inside an absorption module 12. Such pulsing of the gas/liquid mixture may be dependent on the geometric architecture of the packing arrangement (Corrugated Screen Packing (CSP)), the particular flowrates of liquid and gas used, and the interaction between liquid and gas.

The system 10 includes an input system that is configured to introduce or inject a process fluid (e.g., the gas 14, contaminated with carbon dioxide or other target species to be removed) and a liquid (e.g., the solvent 16) into the absorption modules 12a-1 through 12e-1 of stage S1. The input system may include components for facilitating even distribution of process fluid and solvent among the stage S1 modules.

For example, the input flow system includes a process fluid conduit 20 that receives the gas 14, which at this point is “contaminated” gas 14C, defined as gas (e.g., air, flue gas, etc.) having an initial concentration of one or more target species) and directs the gas to each module of the stage S1. An airflow control device, such as a gas flow straightener 22, functions to direct a portion of the air vertically and in a distributed manner into a respective absorption module 12. A liquid injection device, such as a spray bar 24, is configured to receive a portion of the solvent 16 (which at this point is a “lean” solvent 16L) and inject the portion in a distributed manner into a respective module of stage S1.

The system 10 also includes a separator 26 at the bottom of each column for separating the process fluid (which at this point is considered “clean” or “treated” gas 14T, since some or all of the target species has been removed) from the solvent 16 (which at this point is a “rich” solvent 16R that has absorbed the removed target species). The rich solvent 16R falls through the separator 26 to a chamber 28.

The system 10 may include one or more flow control and monitoring systems for regulating the flow of the air 14 and the solvent 16. In an embodiment, the system 10 includes a liquid flow control system 30 that includes a controller 32 and a controllable valve 34 in communication with each stage S1 module. The controller 30 may control the valves 34 to adjust the flow rate of lean solvent based on flow measurements (e.g., flow rate of rich solvent 16R and/or flow rate of clean gas 14) and/or instructions from another controller or processor.

For example, as shown in FIG. 1, a valve 34 is disposed in fluid communication with the flow of lean solvent 16L, and in fluid communication with a respective spray bar 24. It is noted that the flow of lean solvent 16L through the valves 34 is isolated from the flow of gas 14 through the straighteners 22.

The system 10 may also include a process fluid flow control system 40 that includes a controller 42 and controllable valves 44. A valve 44 is provided for each stage S1 module, and each valve 44 is disposed in fluid communication with the process fluid conduit 20 and one of the absorption modules of the stage S1. An additional outlet valve 46 may be provided to regulate the flow rate of treated gas 14T exiting the system 10. The controller 42 may control the valves 44 and 46 to adjust the flow rate of the gas 14 through the system 10.

Although the liquid and process fluid control systems are shown as having separate controllers, embodiments are not so limited. For example, the control systems may instead have a single processor or controller configured to monitor flow and control the valves 34, the valves 44 and/or the outlet valve 46.

In use, the gas 14 is injected into each stage S1 module via the process fluid conduit 20 and the gas flow straighteners 22. Simultaneously, lean solvent 16L is introduced via the spray bars 24.

Injected portions of the gas 14 and the solvent 16 flow in parallel through each stage S1 module, where some of a target species such as CO2 is absorbed into the solvent 16 (facilitated, for example, by an RFC in each module 12). The gas 14 and the solvent 16 flow co-currently through successive stages and through the connectors 18, so that the concentration of CO2 in the gas 14 is successively reduced. Rich solvent 16R and treated gas 14T at the bottom of the system 10 may be separated and directed to other locations. For example, the rich solvent 16R may be transferred to a separation system (not shown) for separating the CO2 from the rich solvent 16R. The CO2 may be used or stored as desired (e.g., sequestered in a subterranean region, sent to a processing facility, etc.)

The flow may be independently regulated in each column using the process fluid flow control system 40 and/or the liquid flow control system 30. For example, the valves 44 and/or the valve 46 may be controlled to increase the gas pressure at the downstream of the column. This feature allows adjusting the system pressure to improve the rate of absorption (mass transfer coefficient), and minimize the evaporation (slip) of volatile solvents. Also, increasing the downstream pressure can improve the flow regime characteristics in the co-current stages, depending on the operational conditions and configured porous media each stage.

Flow regulation may include shutting off one or more valves to isolate a respective column from the system 10. This may be desirable in instances such as changes in gas flow (e.g., a reduction in input process fluid volume), and instances where operational requirements are adjusted (e.g., turned down).

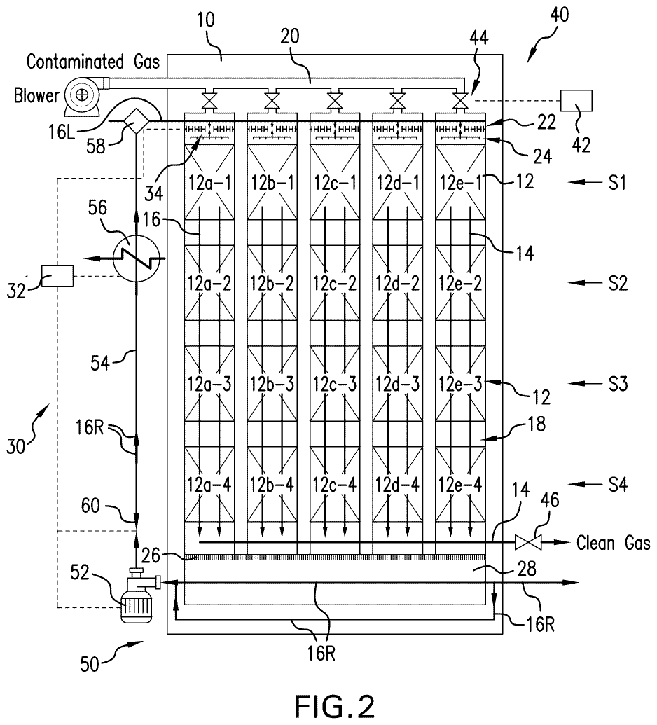

FIGS. 2-4 depict embodiments of the system 10, in which a combination of co-current and counter-current flow is employed. In this embodiment, the system 10 includes a circulation system 50 that is configured to direct all or at least a portion of the solvent in a counter-current manner.

Combining both co-current and counter-current flow improves the performance of the system 10. Each stage S1-S4 is configured for co-current flow, in which both, a process fluid (e.g., flue gas, air, etc.) and a solvent (or other liquid) flow in the same general direction. The flow of process fluid and solvent is counter-current between different stages to improve the overall performance of the absorption system.

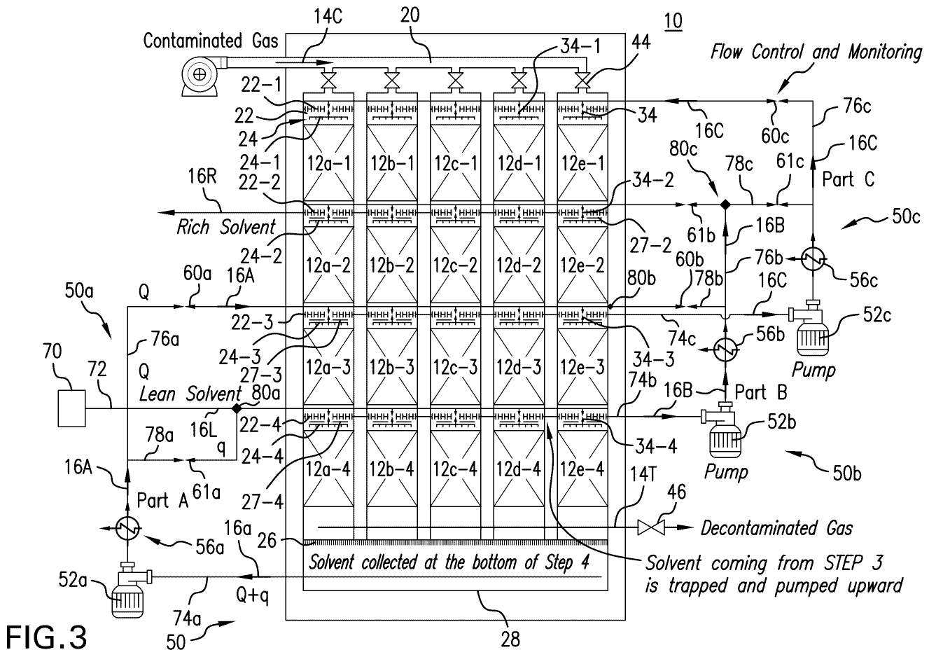

Generally, in these embodiments, the gas 14 and the solvent 16 flow through each stage co-currently in a first general direction (e.g., vertically downward along each column). The circulation system 50 directs at least a portion of the solvent 16 (which may be rich solvent 16R, or partially rich solvent) counter-currently with respect to the first direction (e.g., vertically upward). The portion of the solvent 16 may be rich solvent 16R recirculated from the last stage of the system 10 (e.g., as shown in FIG. 2, or partially rich solvent circulated from one stage to another (e.g., as shown in FIG. 3). The circulation system 50 may include one or more devices for changing a temperature or other parameter of the solvent 16 to improve the absorption process.

In an embodiment, the solvent 16 is flowed counter-currently by directing at least a portion of the solvent 16 from an output of a given absorption module (also referred to as a latter absorption module) to an input of a different absorption module. The different absorption module is located above or before the latter absorption module. A module is “before” another module in a series of modules when the module is positioned in the series such that the gas 14 (or other process fluid) flows through the module prior to flowing through the another. In vertical arrays of modules, a module located above another module is considered to be located “before” the another module.

Temperature control as described herein imparts various advantages. For example, the temperature may be controlled by keeping the temperature of process fluid below a desired level, in order to favor the exothermic absorption process and reduce the slip of solvent into the gas phase.

FIG. 2 shows an embodiment of the system 10 including the circulation system 50. In this embodiment, the circulation system 50 includes a pump 52 in fluid communication with the chamber 28. A flow line 54 directs a fraction of the rich solvent 16R though a temperature control device, such as a chiller 56. The rich solvent 16R is chilled as it passes through the chiller 56. The flow line 54 directs the chilled rich solvent 16R back to the top of the columns.

Returning the fraction of chilled rich solvent 16R allows for re-use of the rich solvent 16R (reducing the overall loading of solvent needed), and also provides for temperature control. Return of the solvent after chilling, as described herein, contributes to lowering the duty of a regeneration system (regenerating the lean solvent 16L from a rich solvent 16R via heating and boiling).

The circulation system 50 may include a mixing valve 58 that combines rich solvent 16R with lean solvent 16L prior to entering the spray bars 24. The mixing valve 58 is operable (e.g., via the controller 32) to control the amount of rich solvent 16R that is mixed with a given volume of lean solvent 16L. The mixing valve 58 also prevents lean solvent 16L from entering the flow line 54 (bypassing the stages), and also prevents partially rich solvent (i.e., solvent that has not yet flowed through all of the stages S1-S4) from flowing toward a source of the lean solvent.

As solvent proceeds through the stages, the solvent temperature increases. The chiller 56 reduces the temperature so that system performance (mass transfer) is not significantly affected. For example, reducing the temperature avoids significant and/or abrupt increases in temperature when the rich solvent is mixed with lean solvent entering the system 10.

The chiller 56 reduces the temperature of the rich solvent 16R to prevent affecting the system performance by shifting the gas-solvent equilibrium line toward a lower concertation of solute in the gas phase and a higher concentration in the liquid phase.

Various components of the circulation system 50 may be controlled by the controller 32 (or other suitable processor) to adjust flow rate, temperature and/or other parameters. For example, a valve 60 and the mixing valve 58 are operable by the controller 32 to control parameters such as the temperature of the rich solvent 16R and the flow rate.

The valve 60 and the mixing valve 58 (optionally in conjunction with operation of the valves 34) may be controlled to adjust the rate of solvent flow through the stages. For example, a Liquid to Gas flow ratio (L/G ratio) can be tuned to precisely obtain desired flow regimes for improving the performance of the co-current absorption column via an optimized fluids hydrodynamics. This improvement reduces the height of each stage, and the total number of stages required to reduce the concentration of a solute or other target species.

FIG. 3 depicts an embodiment of the system 10, which is configured to circulate solvent counter-currently between stages. In this embodiment, the circulation system 50 includes multiple sections 50a, 50b and 50c. Each section is responsible for controlling temperature and circulating solvent between different stages. It is noted that the system 10 may have any number of stages, and the circulation system may have any number of sections.

In this embodiment, each stage S1-S4 is in fluid communication with an input system that includes a spray bar 24 (denoted as spray bars 24-1 through 24-4) and a straightener 22 (denoted as straighteners 22-1 through 22-4). In addition, each input system may include a set of valves 34 as shown (denoted as valves 34-1 through 34-4), allowing for individual control of solvent injection into each module 12.

As shown, the process fluid conduit 20 introduces the gas 14 as contaminated gas 14C above stage S1. A source 70 of the solvent 16 is connected to a lean solvent line 72, which directs lean solvent 16L to a lowermost stage of the system (the last stage). For example, as shown, the solvent line 72 is connected to the spray bars 24-4 and the valves 34-4 between stages 3 and 4. Although the stages as shown as being vertically arrayed, the system 10 is not so limited. For example, the stages S1-S4 may be arrayed horizontally or arranged in any suitable configuration.

The system also includes components between each stage for separating the gas 14 from the liquid solvent 16. These components allow solvent to be separated from gas at each stage and recirculated as discussed further herein. For example, between adjacent stages a separator 27 is disposed above the spray bars 24 that allows gas to pass through, but blocks liquid. The blocked solvent is then pumped out of the stages and is directed counter-currently to another stage. In this example, separators 27-2, 27-3 and 27-4 are disposed above stages S2, S3 and S4, respectively.

Each separator 27 is disposed between a straightener 22 and a spray bar 24, so that solvent 16 exiting a given stage is prevented from entering an adjacent stage, while gas 14 is allowed to enter the adjacent stage. For example, each separator 27 includes a perforated tray (e.g., having holes with a chimney vent cap mechanism) that is utilized to collect the solvent 16 while allowing the gas 14 to continue its downward flow.

The circulation system 50 includes a first section 50a, which is configured to direct solvent 16 collected at the bottom of stage S4 (denoted as solvent 16A). A pump 52a and a flowline 74a direct the collected solvent 16A (which has increased in temperature due to reactions in stage S4) to a chiller 56a. A flow line 76a directs cooled solvent 16A to the spray bars 24-3 between stages S2 and S3, and may include a valve 60a for controlling flow of the solvent 16A into the stage S3.

The section 50 a may also include a bypass flow line 78a, which directs a portion or fraction of the solvent 16A in the flow line 76a to a mixing valve 80a. The mixing valve 80a combines some of the cooled solvent 16A with lean solvent 16L entering the system 10. A valve 61a connected to the flow line 76a, and/or the mixing valve 80a, may be controlled to regulate parameters such as the temperature of solvent 16 entering stage S4, and the L/G ratio.

The second section 50b includes a pump 52b configured to draw separated solvent 16 (denoted as solvent 16B) exiting stage S3 via a flow line 74b. A chiller 56b is configured to cool the separated solvent 16B, and a flow line 76b directs the cooled solvent 16B to a bottom of stage S1. The second section 50b may also include a flow line 78b and a mixing valve 80b for mixing a portion of the solvent 16B with solvent 16A between stages S2 and S3. The flow line may include a valve 60b for controlling an amount of the solvent 16B flow that is mixed.

The third section 50c includes a pump 52c configured to draw separated solvent 16 (denoted as solvent 16C) from the bottom of stage S2 via a flow line 74c. A chiller 56c is configured to cool the separated solvent 16C, and a flow line 76c directs the cooled solvent 16C to the top of stage S1. The third section 50c may also include a flow line 78c and a mixing valve 80c for mixing a portion of the solvent 16C with solvent between stages S1 and S2. The flow line 76c may include a valve 60c for controlling an amount of the solvent 16C that is flowed to the stage S1, and/or a valve 61c for controlling an amount of the solvent 16C that is mixed with the solvent 16B. A valve 61b may be included for controlling flow of the mixture of solvent 16B and 16C that enters stage S2.

In an embodiment, each section of the circulation system 50 is independently controllable by the controller 32 or other suitable processor. For example, the valve 60a is controllable to adjust the flow rate of solvent to stage S3, and the valve 61a and/or the valve 80a is/are controllable to control the flow rate of cooled solvent that will be mixed with the lean solvent 16L. The valve 60b is controllable to adjust solvent flow between stages S2 and S3, and valve 60c is controllable to adjust solvent flow to stage S1.

In use, the contaminated gas 14C is injected into the system via the conduit 20, flows downward through each stage, and treated gas 14T is collected below stage S4. At the bottom of each stage, the gas flow is separated from the solvent 16, and the gas 14 continues to flow downward passing through flow straighteners 22.

Generally, the lean solvent 16L is input to the lowermost (the last) stage of the system 10, and solvent 16 from the bottom of each stage is collected and circulated upward to successively higher stages. Thus, in this embodiment, the solvent 16 becomes richer as it flows though successively higher stages and is removed from the system after flowing through the uppermost stage.

In this embodiment, a source of fresh solvent 16L at an initial temperature is flowed to the top of stage S4 and distributed between each column at stage S4 (modules 12a-4, 12b-4, 12c-4, 12d-4) via the flow control valves 34-4 and connected spray bars 24-4. The solvent 16 absorbs the target species in the gas (e.g., CO2 in a flue gas) and is normally heated due to an exothermic reaction between the gas 14 and the solvent 16 in stage S4.

Solvent 16 exiting stage S4 is separated and collected at the chamber 28, and circulated back to the top of stage S3, passing through the chiller 56a (cooling down for a better absorption in stage S3). A fraction of cooled solvent 16A collected at the bottom of stage S4 is recirculated to the top of stage S4 via the flow line 78a and the mixing valve 80a. This helps with maintaining a desirable flow regime via improved control over the gas/liquid flow ratio, which may depend on the type of porous media used in the modules 12a-1 through 12a-4.

At the bottom of stage S3, the solvent 16B is separated from the gas 14, collected in a sump, and pumped upward to the chiller 56b. A fraction of the solvent 16B entering stage S3, is combined with solvent 16 between stages S2 and S3 (via the flow line 78b), and another fraction of the solvent 16B is combined with solvent between stages S1 and S2. The mixing valves 80b and 80c are controlled to control the flow rate and proportion of solvent being mixed, for obtaining a desired flow regime.

Similarly, at the bottom of stage S2, the solvent 16C is separated from the gas 14, collected, and pumped upward to the chiller 56c. A fraction of the solvent 16C is combined with solvent 16 between the stages S1 and S2 (via the flow line 78c), and a fraction of the solvent 16C is directed to the top of the stage S1 (via the flow line 76c). The solvent 16 exits stage S1 and is now rich solvent 16R, which has been passed through all four stages and absorbed CO2. The rich solvent 16R may be directed to a regenerator to allow for removing the CO2 and re-using the solvent 16.

As discussed above, aspects of the liquid flow control system 30, the process fluid flow control system and/or the circulation system 50 may be operated to control operational parameters. For example, these systems may be used to control parameters such as temperature, flow rate and L/G ratio to improve or optimize hydrodynamics in the absorption modules 12. For example, the differential concentration of a target species in the gas and liquid phases (as they flow in opposite direction between from one step toward another step) can be maximized, improving mass transfer within an absorption module 12.

L/G ratio (difference in the molar concentration of the soluble species in the liquid phase in the gas-liquid interface vs. the bulk of liquid) has an impact on mass transfer, and can be increased or otherwise controlled by the system 10.

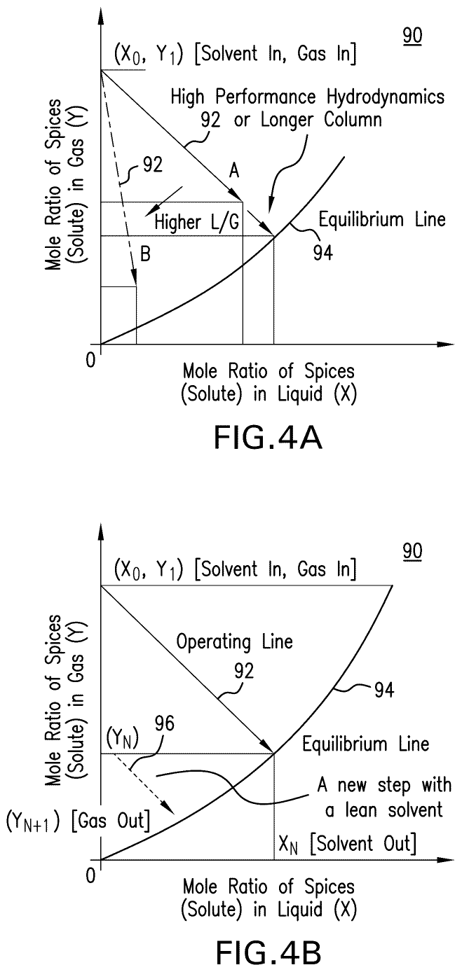

FIGS. 4A and 4B are McCabe-Thiele diagrams 90 that show aspects of solute absorption within a co-current absorber, such as an absorption module 12 including an RFC. These diagrams show the mole ratio of a solute in a gas (e.g., the air 14) as a function of the mole ratio of the solute in a liquid (e.g., the solvent 16).

FIG. 4A includes an operating line 92 (line A), which represents the transfer of a solute (e.g., dissolved CO2) from a gas to a liquid. As shown, in a co-current absorber, solute is absorbed at a constant rate until a dynamic equilibrium condition between gas and liquid phases is reached (equilibrium line 94). By increasing the L/G ratio, hydrodynamic is improved by shifting the operating line 92 (line B), thereby improving the amount of the solute in a given absorption module.

The shift in the operating line 92, and corresponding increase in the amount of solute transferred can be achieved by controlling the L/G ratio as described herein. However, this technique increases the solvent loading and may impact the economy of the process. In a well-designed process, the liquid loading is optimized based on maximizing the mass transfer coefficient. This improvement can be achieved by maximizing the hydrodynamic performance in a stage, such as by utilizing the right porous media and enhancing the rate of liquid phase via recirculating a portion of solvent collected at the bottom of a stage, as described herein.

Another way to improve mass transfer is shown in FIG. 4B, where mass transfer is improved by adding a fresh lean solvent to each stage. However, this method can also impact the economy of the process due to an excessive liquid loading.

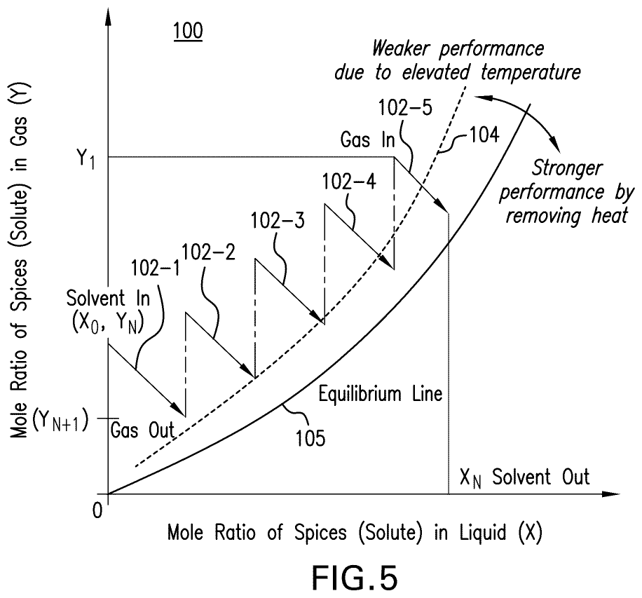

Temperature control may be used as described herein to improve hydrodynamics in the absorption modules. FIG. 5 illustrates how temperature control can improve absorption.

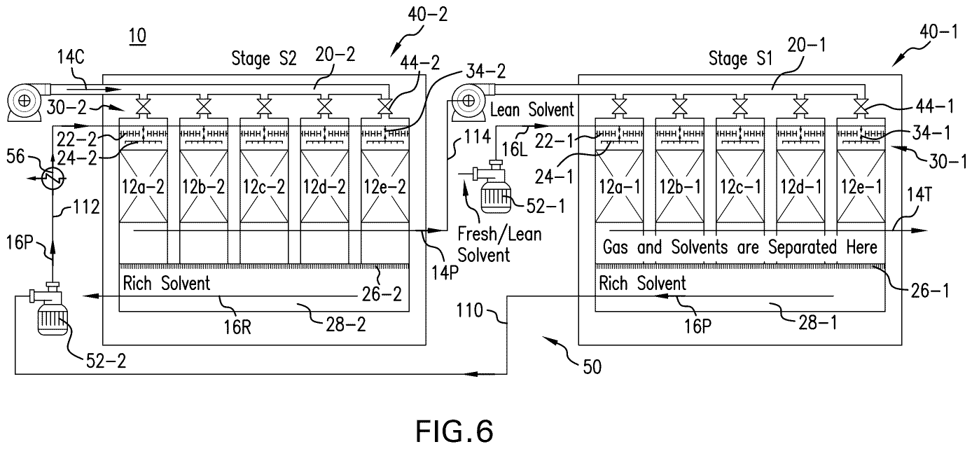

FIG. 5 is a McCabe-Thiele diagram 100 that shows aspects of solute absorption within the system 10 of FIGS. 2-4 (and FIG. 6, discussed further herein).

An operating line 102, which represents the transfer of a solute from a gas to a liquid through each stage. Line segments 102-1 through 102-4 represent solute transfer within each stage S1 through S4. At each stage solute is absorbed at a constant rate until a dynamic equilibrium condition between gas and liquid phases is reached (equilibrium line 104).

By lowering temperature and/or maintaining temperature shifts, performance can be improved by shifting the equilibrium line 104 to a new equilibrium line 105. Temperature control also reduces the slip of volatile solvents into the gas phase. Shifting the equilibrium line can also be accomplished by increasing system pressure (e.g., by controlling the gas outlet valve 46).

FIG. 6 depicts an embodiment of the system 10, in which one or more stages are connected to one another via co-current and counter-current liquid flow. The system 10 includes two stages, such as the stages S1 and S2. It is noted that each stage S1 and S2 may represent a single stage, or multiple vertically arrayed stages.

The system 10 in this embodiment includes at least two stages. Instead of the stages being vertically arranged as shown in FIGS. 1-3, the stages in this embodiment are arrayed horizontally. The system 10 in this embodiment is more compact than conventional vertical systems, and may be modular, allowing for rapid deployment of the system 10.

The absorption process is thus extended horizontally, instead of vertical stacking of multiple stages of co-current porous media. The low height absorption packages can be fit inside an easy-to-transport containers equipped with all the required pumps, valves, control systems, instrumentation, chilling unit, blowers, gas/solvent separation system, and electronic systems.

The first stage includes a horizontal array of absorption modules 12a-1, 12b-1, 12c-1, 12d-1 and 12e-1. The second stage includes a horizontal array of absorption modules 12a-2, 12b-2, 12c-2, 12d-2 and 12e-2. A process fluid flow conduit 20-1 is connected to a blower or other source of air or other process fluid. Flow of the process fluid into first stage may be controlled by a process fluid control system 40-1, including a valve 44-1 controllable to control the flow rate of process fluid into the first stage.

A first pump 52-1 is configured to pump lean solvent 16L through a spray bar 24-1 at each absorption module of the first stage S1. The first stage S1 may include a liquid flow control system 30-1 including a valve 34-1 connected to each spray bar 24-1. A separator 26-1 is configured to separate process fluid from solvent 16, so that solvent from the first stage (which at this point has absorbed some of a target species and is partially rich solvent 16P) can be circulated to the second stage S2.

The circulation system 50 in this embodiment includes a liquid flow line 110 connected to a chamber 28-1, which is configured to direct the partially rich solvent 16P counter-currently to the second stage S2. A pump 52-2 is configured to receive the partially rich solvent 16P and direct the solvent 16P via a flow line 112 to an input of the second stage S2. The circulation system 50 may include a chiller 56 to control the temperature of the solvent 16P.

The partially rich solvent 16P is fed to stage S2, absorbs more of the target species, and exits stage S2 as rich solvent 16R. A separator 26-2 separates the rich solvent 16R from the process fluid.

The first and second stages may be connected to a single source of process fluid. Alternatively, each stage may have a respective input system so that a process fluid can be separately injected into each stage. For example, the system 10 includes a first process fluid conduit 20-1 connected to a source of process fluid, such as a blower, and a second process fluid conduit 20-2 connected to another source.

In an embodiment, the second process fluid conduit 20-2 is connected to a source of process fluid such as contaminated gas 14C. The circulation system 50 includes a fluid line 114 configured to direct partially treated gas 14P to the first process fluid conduit 20-1. The partially treated gas 14P is further treated by reacting with the lean solvent 16L, and exits the first stage S1 as treated gas 14T.

Separate sources and input systems allow for multi-stage pressure boosting the system 10, which has the effect of reduction of total heat loss due to gas compression. In addition, a higher gas pressure can be provided to each phase of the co-current system to operate the absorption process under optimal flow conditions under which the rate of absorption is maximized. This depends on the type of the solvent and characteristic of the utilized porous media.

Different types of solvents may be used in different stages. For example, the first stage may be a “rough” stage that uses a relatively cheap solvent (e.g. water). At stage S1, some CO2 is absorbed. Gas is then routed to the second stage, where a more expensive solvent finishes the separation. This allows for lower amounts of more expensive solvents, reducing system costs. In some applications, two different solvents are used to capture one or more target species from a contaminated gas, such as in landfill gas treatment processes.

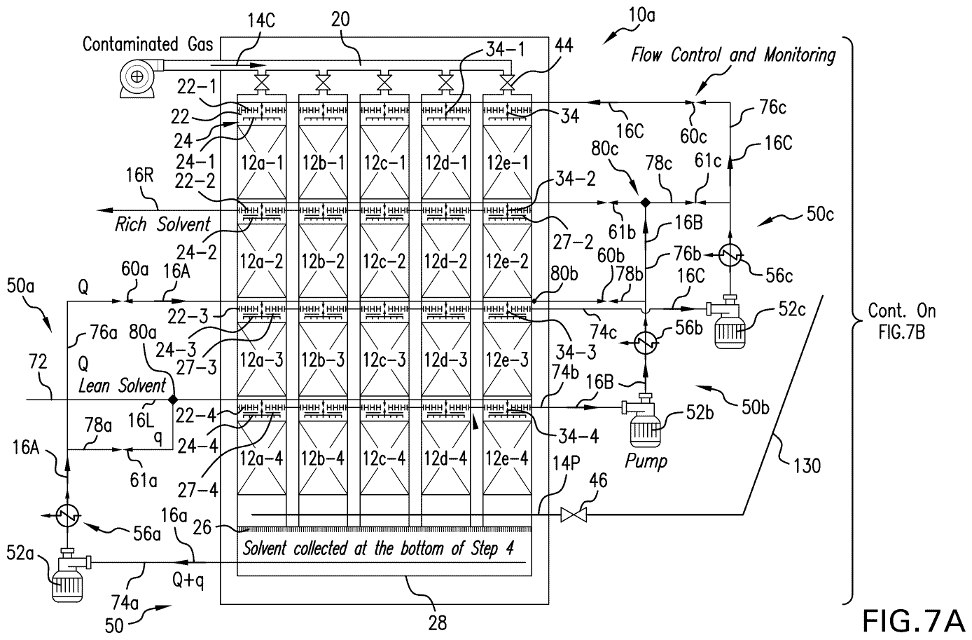

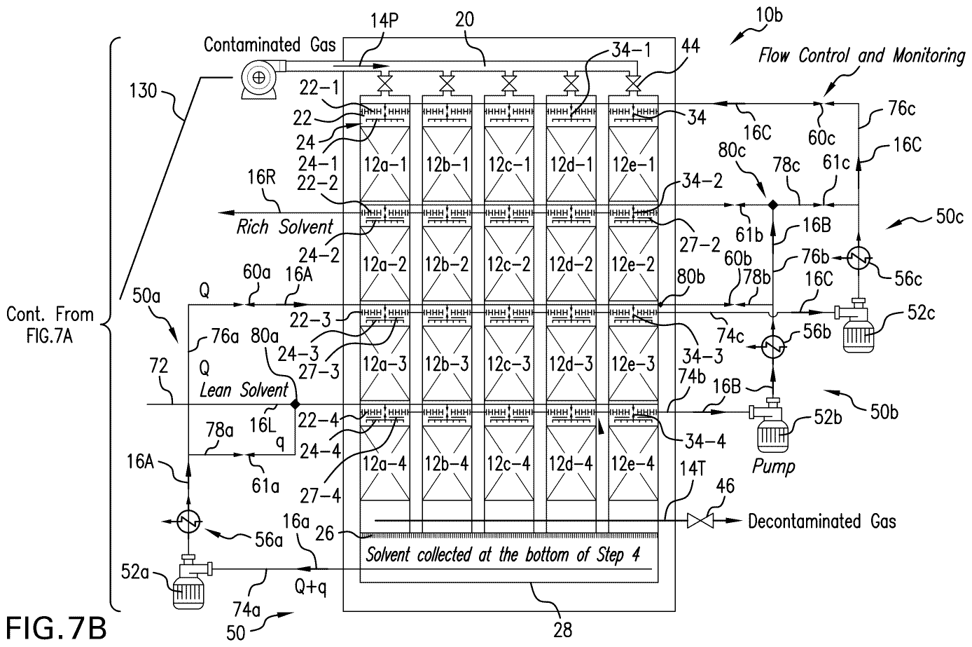

FIG. 7 shows an example in which two multi-stage systems 10 (denoted as 10a and 10b) are connected in parallel, so that different types of solvents can be used. In this example, the system 10a receives a first type of solvent 16 (e.g., a rough solvent such as water), and the gas 14 is treated as discussed above (with reference to FIG. 3). In this example, the gas 14 exiting the system 10 is partially treated gas 14P.

The partially treated gas 14P is connected to the process fluid conduit 20 of the system 10 b by a fluid line 130. The partially treated gas 14P is input to the system 10b and then treated with another solvent 16. The other solvent 16 may be provided to further absorb the same target species, or the other solvent 16 may be provided to absorb a different target species than the species targeted in the system 10a.

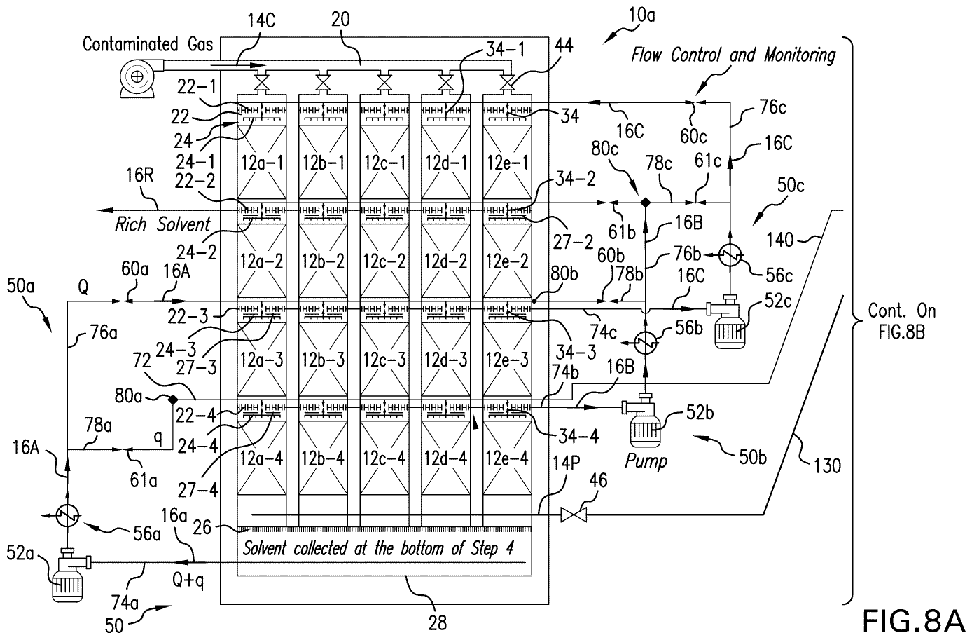

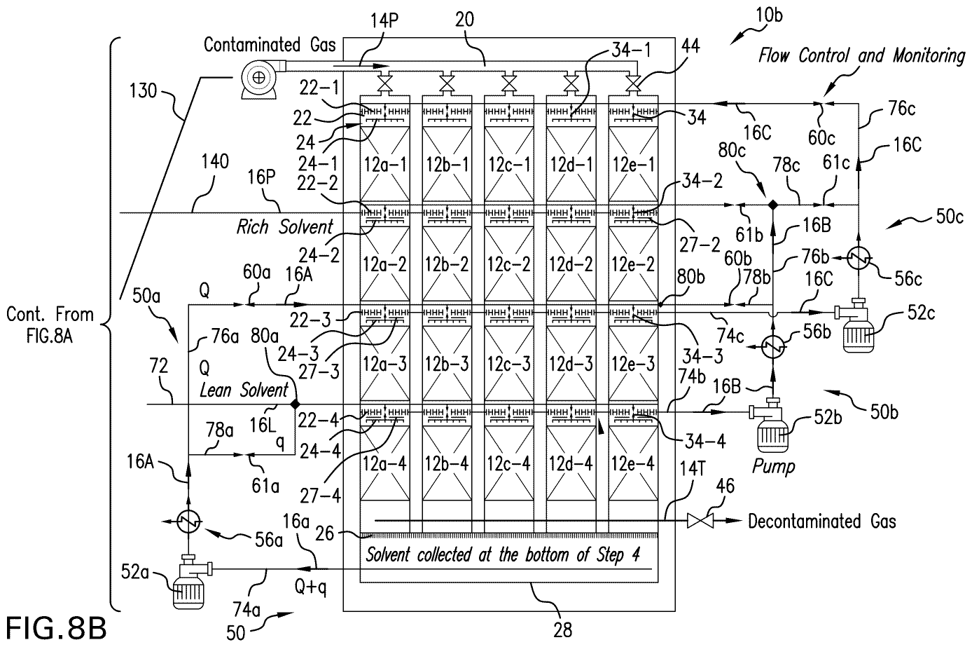

FIG. 8 shows an example in which the two multi-stage systems 10a and 10b are connected in parallel, and are configured to use the same solvent 16. In this example, the solvent 16 is circulated from the second system 10b after flowing through the stages of the system 10 a. A fluid line 140 connects solvent 16 (partially rich solvent 16P) exiting stage S1 of the system 10b, and directs the solvent 16P to stage S4 of the system 10a.

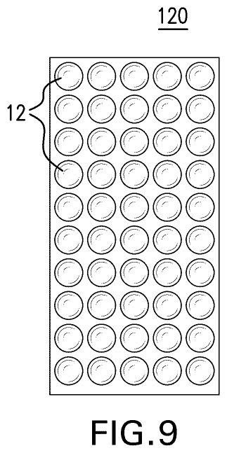

FIG. 9 shows an upper view of an example of an absorption stage 120, which may represent any of the absorption stages described herein. In this example, the absorption stage 120 includes a two-dimensional array of absorption modules 12. The absorption modules 12 are connected so that gas and liquid flow through all of the absorption modules 12 (or at least a subset of the modules 12) in parallel.

In some applications, the allowable column height is limited. For example, in some areas (e.g., geographic regions with permafrost, regions with harsh weather conditions, offshore platforms, etc.) it may not be feasible or possible to create a foundation for a tall column. A horizontal system such as the system of FIG. 6, FIG. 7 and/or FIG. 8 is well suited to such applications.

Set forth below are some embodiments of the foregoing disclosure:

Embodiment 1: A heat and mass transfer system comprising: an absorption system including a series of absorption modules, each absorption module of the series of absorption modules configured to receive a process fluid and a liquid, wherein the process fluid is configured to flow through the series of absorption modules in a first direction, and the process fluid and the liquid are configured to flow co-currently within each absorption module; and a circulation system configured to collect a portion of the liquid from an output of a latter absorption module and circulate the portion of the liquid to an input of a different absorption module, the different absorption module located before the latter absorption module in the series.

Embodiment 2: The heat and mass transfer system of any prior embodiment, wherein the circulation system includes a temperature control device configured to control a temperature of the circulated portion.

Embodiment 3: The heat and mass transfer system of any prior embodiment, wherein the circulation system includes a liquid flow line connecting the output of the latter absorption module to the input of the different absorption module, and a liquid valve configured to be operated to adjust a flow rate of the circulated portion.

Embodiment 4: The heat and mass transfer system of any prior embodiment, wherein the circulation system includes a mixing valve configured to combine an amount of the circulated portion of the liquid with the liquid entering the second absorption module.

Embodiment 5: The heat and mass transfer system of any prior embodiment, further comprising a controller configured to control at least one of the temperature control device, the liquid valve and the mixing valve to maintain a desired temperature of the liquid entering the second absorption module.

Embodiment 6: The heat and mass transfer system of any prior embodiment, wherein the series of absorption modules are arrayed vertically, and the circulation system is configured to inject the liquid at a lowermost absorption module, circulate the liquid in a direction opposite the first direction, and remove the liquid at an output of an uppermost absorption module.

Embodiment 7: The heat and mass transfer system of any prior embodiment, wherein the circulation system includes a plurality of sections, each section configured to circulate a respective portion of the liquid from an output of one absorption module of the series of absorption modules to an input of another absorption module located above the one absorption module, each section including a respective temperature control device.

Embodiment 8: The heat and mass transfer system of any prior embodiment, wherein the series of absorption modules is arrayed horizontally.

Embodiment 9: The heat and mass transfer system of any prior embodiment, further comprising a flow control device configured to be controlled to adjust a flow rate of at least one of the process fluid and the liquid, and a controller configured to control the flow control device based on measurement data related to operation of the absorption system.

Embodiment 10: The heat and mass transfer system of any prior embodiment, wherein the flow control device includes at least one of: a liquid injection device configured to inject the liquid into an absorption module, and a liquid control valve configured to adjust the flow rate of the liquid; and a process fluid control valve configured to adjust the flow rate of the process fluid.

Embodiment 11: A method comprising: inputting a process fluid into a series of absorption modules, each absorption module of the series of absorption modules defining an absorption stage and configured to receive the process fluid and a liquid, wherein the process fluid is configured to flow through the series of absorption modules in a first direction; inputting the liquid into an absorption stage, and flowing the liquid co-currently through the absorption stage with the process fluid, each absorption module causing a transfer of a target species from the process fluid to the liquid; and circulating a portion of the liquid from an output of a latter absorption module to an input of a different absorption module by a circulation system, the different absorption module located before the latter absorption module in the series, to cause the circulated portion to flow counter-currently relative to the process fluid.

Embodiment 12: The method of any prior embodiment, further comprising controlling a temperature of the circulated portion by a temperature control device prior to the circulated portion entering the input of the second absorption module.

Embodiment 13: The method of any prior embodiment, wherein circulating the portion of the liquid includes adjusting a flow rate of the circulated portion.

Embodiment 14: The method of any prior embodiment, wherein circulating the portion of the liquid includes combining an amount of the circulated portion with the liquid entering the second absorption module.

Embodiment 15: The method of any prior embodiment, wherein circulating the portion of the liquid includes controlling a proportion of the amount of the circulated portion to the liquid entering the second absorption module to maintain a desired temperature of the liquid entering the second absorption module.

Embodiment 16: The method of any prior embodiment, wherein the series of absorption modules are arrayed vertically, and the circulation system is configured to inject the liquid at a lowermost absorption module, circulate the liquid in a direction opposite the first direction, and remove the liquid at an output of an uppermost absorption module.

Embodiment 17: The method of any prior embodiment, wherein the circulation system includes a plurality of sections, each section configured to circulate a respective portion of the liquid from an output of one absorption module of the series of absorption modules to an input of another absorption module located above the one absorption module, each section including a respective temperature control device.

Embodiment 18: The method of any prior embodiment, wherein the series of absorption modules is arrayed horizontally.

Embodiment 19: The method of any prior embodiment, further comprising adjusting a flow rate of at least one of the process fluid and the liquid, based on measurement data related to operation of the absorption system.

Embodiment 20: The method of any prior embodiment, wherein adjusting the flow rate is performed by controlling at least one of: a liquid control valve connected to a liquid injection device, the liquid injection device configured to inject the liquid into an absorption module; and a process fluid control valve connected to a process fluid conduit, the process fluid conduit configured to flow the process fluid into the series of absorption modules.

The use of the terms “a” and “an” and “the” and similar referents in the context of describing the invention (especially in the context of the following claims) are to be construed to cover both the singular and the plural, unless otherwise indicated herein or clearly contradicted by context. Further, it should be noted that the terms “first,” “second,” and the like herein do not denote any order, quantity, or importance, but rather are used to distinguish one element from another. The terms “about”, “substantially” and “generally” are intended to include the degree of error associated with measurement of the particular quantity based upon the equipment available at the time of filing the application. For example, “about” and/or “substantially” and/or “generally” includes a range of ±8% of a given value.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited.

What is claimed is:

1. A heat and mass transfer system comprising:
an absorption system including a series of absorption modules, each absorption module of the series of absorption modules configured to receive a process fluid and a liquid, wherein the process fluid is configured to flow through the series of absorption modules in a first direction, and the process fluid and the liquid are configured to flow co-currently within each absorption module; and
a circulation system configured to collect a portion of the liquid from an output of a latter absorption module and circulate the portion of the liquid to an input of a different absorption module, the different absorption module located before the latter absorption module in the series.

2. The heat and mass transfer system of claim 1, wherein the circulation system includes a temperature control device configured to control a temperature of the circulated portion.

3. The heat and mass transfer system of claim 2, wherein the circulation system includes a liquid flow line connecting the output of the latter absorption module to the input of the different absorption module, and a liquid valve configured to be operated to adjust a flow rate of the circulated portion.

4. The heat and mass transfer system of claim 3, wherein the circulation system includes a mixing valve configured to combine an amount of the circulated portion of the liquid with the liquid entering the second absorption module.

5. The heat and mass transfer system of claim 4, further comprising a controller configured to control at least one of the temperature control device, the liquid valve and the mixing valve to maintain a desired temperature of the liquid entering the second absorption module.

6. The heat and mass transfer system of claim 1, wherein the series of absorption modules are arrayed vertically, and the circulation system is configured to inject the liquid at a lowermost absorption module, circulate the liquid in a direction opposite the first direction, and remove the liquid at an output of an uppermost absorption module.

7. The heat and mass transfer system of claim 6, wherein the circulation system includes a plurality of sections, each section configured to circulate a respective portion of the liquid from an output of one absorption module of the series of absorption modules to an input of another absorption module located above the one absorption module, each section including a respective temperature control device.

8. The heat and mass transfer system of claim 1, wherein the series of absorption modules is arrayed horizontally.

9. The heat and mass transfer system of claim 1, further comprising a flow control device configured to be controlled to adjust a flow rate of at least one of the process fluid and the liquid, and a controller configured to control the flow control device based on measurement data related to operation of the absorption system.

10. The heat and mass transfer system of claim 9, wherein the flow control device includes at least one of:
a liquid injection device configured to inject the liquid into an absorption module, and a liquid control valve configured to adjust the flow rate of the liquid; and
a process fluid control valve configured to adjust the flow rate of the process fluid.

11. A method comprising:
inputting a process fluid into a series of absorption modules, each absorption module of the series of absorption modules defining an absorption stage and configured to receive the process fluid and a liquid, wherein the process fluid is configured to flow through the series of absorption modules in a first direction;
inputting the liquid into an absorption stage, and flowing the liquid co-currently through the absorption stage with the process fluid, each absorption module causing a transfer of a target species from the process fluid to the liquid; and
circulating a portion of the liquid from an output of a latter absorption module to an input of a different absorption module by a circulation system, the different absorption module located before the latter absorption module in the series, to cause the circulated portion to flow counter-currently relative to the process fluid.

12. The method of claim 11, further comprising controlling a temperature of the circulated portion by a temperature control device prior to the circulated portion entering the input of the second absorption module.

13. The method of claim 11, wherein circulating the portion of the liquid includes adjusting a flow rate of the circulated portion.

14. The method of claim 11, wherein circulating the portion of the liquid includes combining an amount of the circulated portion with the liquid entering the second absorption module.

15. The method of claim 14, wherein circulating the portion of the liquid includes controlling a proportion of the amount of the circulated portion to the liquid entering the second absorption module to maintain a desired temperature of the liquid entering the second absorption module.

16. The method of claim 1, wherein the series of absorption modules are arrayed vertically, and the circulation system is configured to inject the liquid at a lowermost absorption module, circulate the liquid in a direction opposite the first direction, and remove the liquid at an output of an uppermost absorption module.

17. The method of claim 16, wherein the circulation system includes a plurality of sections, each section configured to circulate a respective portion of the liquid from an output of one absorption module of the series of absorption modules to an input of another absorption module located above the one absorption module, each section including a respective temperature control device.

18. The method of claim 11, wherein the series of absorption modules is arrayed horizontally.

19. The method of claim 11, further comprising adjusting a flow rate of at least one of the process fluid and the liquid, based on measurement data related to operation of the absorption system.

20. The method of claim 11, wherein adjusting the flow rate is performed by controlling at least one of:
a liquid control valve connected to a liquid injection device, the liquid injection device configured to inject the liquid into an absorption module; and
a process fluid control valve connected to a process fluid conduit, the process fluid conduit configured to flow the process fluid into the series of absorption modules.
